(19) United States
(12) Patent Application Publication
(10) Pub. No.: US 2005/0270977 A1
(43) Pub. Date: Dec. 8, 2005

(54) Combined queue WME quality of service management

(75) Inventors: Wayne King, Kirkland, WA (US); Thomas Kuehnel, Seattle, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/861,573

(22) Filed: Jun. 7, 2004

(51) Int. Cl. H04L 1/00

(52) U.S. Cl. 370/235

(57) ABSTRACT

Methods and apparatuses are provided for using a single transmit queue to transmit a plurality of access categories in an IEEE 802.11 system. To use a single transmit queue, conventional frame descriptors that are used to pass data frames between the wireless NIC and the host are modified to include access parameters for the packets that are associated with the frame descriptors. This allows transmission hardware to dynamically change how each packet is transmitted. For example, the contention policies may be implemented on a packet-by-packet basis, even from a single transmit queue. Also, packets of various access categories into appropriate positions within the single transmit queue.

### FIELD OF THE INVENTION

The present invention is directed to implementation of priorities QoS in an IEEE 802.11 network.

### BACKGROUND OF THE INVENTION

As wireless IEEE 802.11 based networks become ubiquitous, the need to provide Quality of Service (QoS) to applications has become more important than ever. The IEEE 802.11 standardization organization provides QoS enhancements of the IEEE 802.11 Media Access Control (MAC) protocol, which is based on two paradigms: parameterized QoS and prioritized QoS. WME (Wireless Multimedia Extensions) defines the subset of prioritized QoS for IEEE 802.11. While parameterized QoS uses a central scheduler to grant medium access, prioritized QoS uses a more distributed approach that differentiates traffic based on priority, thereby providing prioritized access to the shared medium. Prioritized access assumes that different traffic types, like voice, video, and data, are treated differently during the arbitration process between stations desiring to transmit simultaneously. WME defines four access categories (ACs) that each use different access parameter values. The access parameter values determine how the transmission contention mechanisms operate, as well as the durations the station can own the medium access. The WME access parameters are: AIFS (arbitration interframe spacing), cwmin (contention window minimum value), cwmax (contention window maximum value), and txoplimit (transmit opportunity limit duration).

To implement prioritized medium access, IEEE 802.11 assumes that a different queue is used for each AC. Referring to FIG. 1, a conventional implementation of WME QoS transmission implements AC mapping of IEEE 802.1D tagged data packets to one of four ACs. Each AC has its own transmit queue 102, 103, 104, 105, and each transmit queue has its own collision resolution functionality 106, 107, 108, 109.

Unfortunately, implementing four separate transmit queues has proven to be costly. Also, since the transmit queues have been conventionally implemented in hardware due to IEEE 802.11 timing requirements, four separate transmit queues require a large amount of integrated circuit real estate as well as power. Because many devices that utilize IEEE 802.11 are wireless, portable, and operate on battery power, it is desirable to reduce the power requirements, cost, and size of the transmission hardware. In addition, it is desirable to provide a way to implement at least a portion of what has traditionally been transmission hardware, as software. This may allow a more simplified hardware design and provide for flexibility in updating and revising the software portion.

### SUMMARY OF THE INVENTION

Aspects of the present invention are directed to providing a transmit queue to transmit a plurality of access categories in an IEEE 802.11 system. For example, a single transmit queue may be used to transmit packets associated with all four different WME access categories. In doing so, power and integrated circuit space requirements associated with a transmit queue may be reduced by up to fourfold, and possibly more.

Further aspects of the present invention are directed to modifying frame descriptors that provide the logical interface between the NIC and the host computer to include access parameters for the packets that are associated with the frame descriptors. This allows transmission hardware to dynamically change how each packet is transmitted. For example, the contention policies may be implemented on a packet-by-packet basis, even from a single transmit queue.

Still further aspects of the present invention are directed to inserting packets of various access categories into appropriate positions within the same transmit queue. In this way, higher priority packets may be transmitted with less delay than lower priority packets.

These and other aspects of the invention will be apparent upon consideration of the following detailed description of illustrative embodiments.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 is a functional block diagram of a conventional system used to transmit in accordance with WME QoS.

FIG. 2 is an illustrative functional block diagram of a network interface card (NIC).

FIG. 3 is an illustrative functional block diagram of a priority resolver, transmit engine, and transmit queue.

FIGS. 4, 5, and 6 are illustrative representations of how packets may be inserted into the transmit queue.

FIG. 7 is a representation of an illustrative frame descriptor.

FIG. 8 is an illustrative functional block diagram of a priority resolver.

FIG. 9 is an illustrative flow chart showing steps that may be taken when preparing a packet for transmission.

FIG. 10 is an illustrative functional block diagram of a transmit engine.

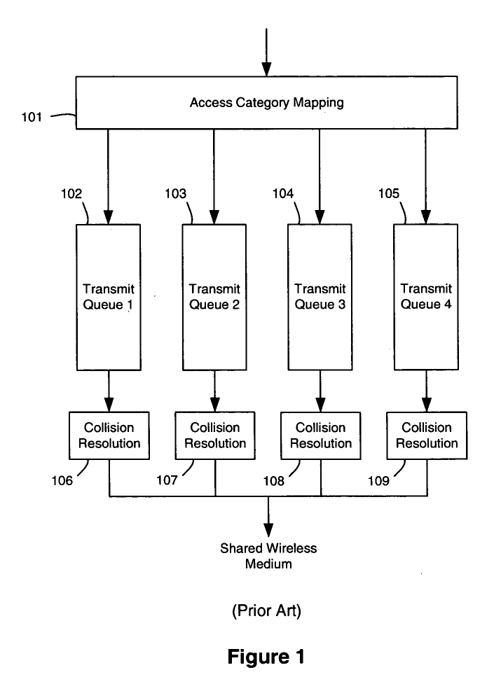

### DETAILED DESCRIPTION OF ILLUSTRATIVE EMBODIMENTS

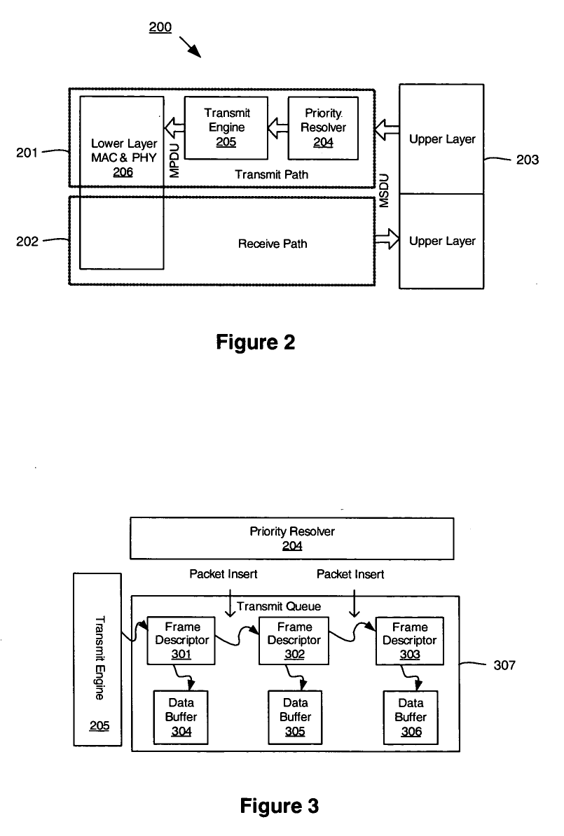

Referring to FIG. 2, an illustrative functional block diagram of a WME-based interface, such as a network interface card (NIC) 200, is shown. The NIC 200 includes a transmit path 201 and a receive path 202 that transfer media access control (MAC) service data units (MSDUs) to and from an upper layer MAC 203.

The transmit path includes a priority resolver 204 and a transmit engine 205. The priority resolver 204 assigns an access category (AC) to each MSDU packet and forwards the MSDU packets to the transmit engine 205. The IEEE 802.11 standard defines four ACs: Background, Best Effort, Video, and Voice. Depending upon the AC assigned to a particular MDSU packet, the transmit engine 205 applies one or more enhanced distributed channel access function (EDCA) access parameters to the packet, such as the defined transmit opportunity limit duration (txoplimit), arbitration inter frame space (AIFS) interval, and/or the contention window (CW) interval (designated by CWmin and CWmax). Each packet may carry its own access parameters, and so the access parameters may be set on a per packet basis. The access parameters may be part of, e.g., the frame descriptor, which has conventionally been used to create linked buffer lists.

The transmit engine 205 also incorporates a mechanism for accessing the shared wireless medium via a lower layer 206, and for transmitting the packets as MAC payload data units (MPDUs) into the shared medium. Such a mechanism includes a transmit queue. However, unlike conventional WME QoS transmission systems having a different dedicated queue for each AC, the transmit queue may be a single transmit queue that is shared between or among a plurality of ACs. For example, a single transmit queue may be used for two, three, or all four ACs. Where the single transmit queue is used for less than all of the ACs, an additional one or more transmit queues may be used for the remaining ACs.

FIG. 3 shows an illustrative queue model and a relationship between the transmit engine 205, the priority resolver 204, and single transmit queue 307. The transmit queue 307 may be implemented as, e.g., a linked list stored in memory or another computer-readable medium. Linked-list queues are known. To add an MPDU packet to the transmit queue 307, the transmit engine 205 adds the appropriate access parameters to the frame descriptor associated with the MPDU. The transmit engine 205 fetches a new MPDU packet from the transmit queue 307, which may occur following successful transmission of the previous MPDU packet. To reduce the probability of head of line (HOL) blocking, the transmit queue 307 may be short, such as one, two, or three MPDUs in length. However, the transmit queue 307 may be longer than three MPDUs if desired. The transmit engine 205 may implement the known IEEE 802.11/WME Carrier Sense, Multiple Access/Collision Avoidance (CSMA/CA) protocol, which involves adding a sequence number prior to the transmission of each MPDU packet. The sequence number may be part of the access parameter info field, further simplifying the transmit engine 205. Due to the time constraints associated with 802.11 medium access, it may be desirable to partially or fully implement the transmit engine 205 in hardware, which is typically faster than software. However, the transmit engine 205 may be partially or fully implemented in software.

The priority resolver 204 may more easily be implemented in software since its timing requirements are not as strict as those of the transmit engine 205. However, the priority resolver 204 may be implemented in software and/or hardware. The priority resolver 204 maintains the order of the transmit queue 307 and generates the access parameter structure for each packet. The priority resolver 204 receives an MSDU packet from the upper layer 203, along with the priority information associated with the MSDU packet, such as an IEEE 802.1D tag of the data packet. The priority resolver 204 uniquely maps each 802.1D tag into a corresponding AC and/or corresponding access parameters (AIFS, CWmin, and/or CWmax) as shown in Table 1. The priority resolver 204 fills in the access parameter into the corresponding access parameter info structure that it associates with the packet. The access parameters may be updated following reception of changed access parameter values transmitted in the beacon by the access point. As previously mentioned, the access parameters may be part of the frame descriptor.

TABLE 1
Mapping of 802.1D Tags With ACs and Access Parameters

| | 802.11 Access | EDCA Access Parameters | | |
|---|---|---|---|---|
| 802.1D Tag | Category | AIFS | CWmin | CWmax |
| 1 | 0: Background | 7 | 15 | 31 |
| 2 | 0: Background | 7 | 15 | 31 |
| 0 | 1: Best Effort | 3 | 15 | 31 |
| 3 | 1: Best Effort | 2 | 7 | 15 |
| 4 | 2: Video | 2 | 7 | 15 |
| 5 | 2: Video | 2 | 7 | 15 |
| 6 | 3: Voice | 2 | 3 | 7 |
| 7 | 3: Voice | 2 | 3 | 7 |

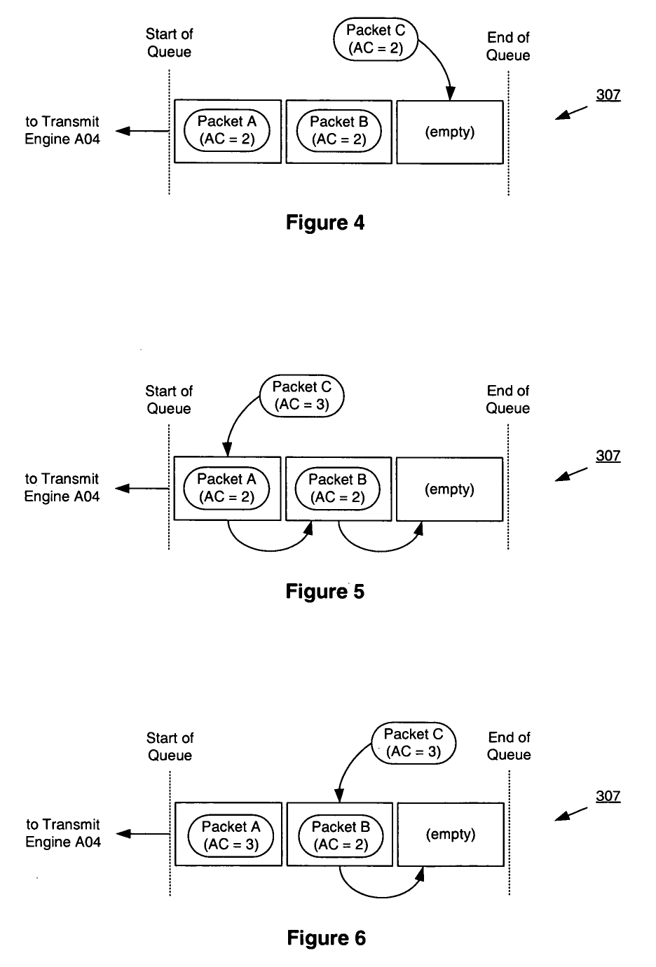

The priority resolver 204 may insert the packet into the transmit queue 307 based on the priority and/or arrival time of the packet. The transmit queue 307 may be implemented as, e.g., a linked list. When inserting a packet into the transmit queue 307, the priority resolver 204 may parse the linked list and insert the packet behind the last packet of equal priority already stored in the transmit queue 307. If there are no packets in the transmit queue 307 of equal priority, then the packet is inserted behind a packet having the next highest priority. If there are no packets having a higher priority, then the packet is inserted at the start of the transmit queue 307. For example, referring to FIG. 4, assume that the transmit queue 307, being three packets in length, already contains two packets A and B, each being assigned AC=2 (video). A third packet C is to be inserted into the transmit queue 307. In this example, packet C is also assigned AC=2, and so packet C is inserted behind the last packet of equal priority already in the transmit queue 307, which in this case is packet B. Referring to FIG. 5, now assume that packet C is assigned AC=3 (voice). In this instance, since the transmit queue 307 does not already contain a packet of equal or higher priority, packet C is inserted at the start of the transmit queue 307. This causes packets A and B to effectively move backward in the transmit queue 307 to make room for packet C. Referring to FIG. 6, now assume that packet A is assigned AC=3. In this case, packet C would be inserted behind packet A, which is the last packet in the transmit queue 307 having a priority equal to the priority of packet C.

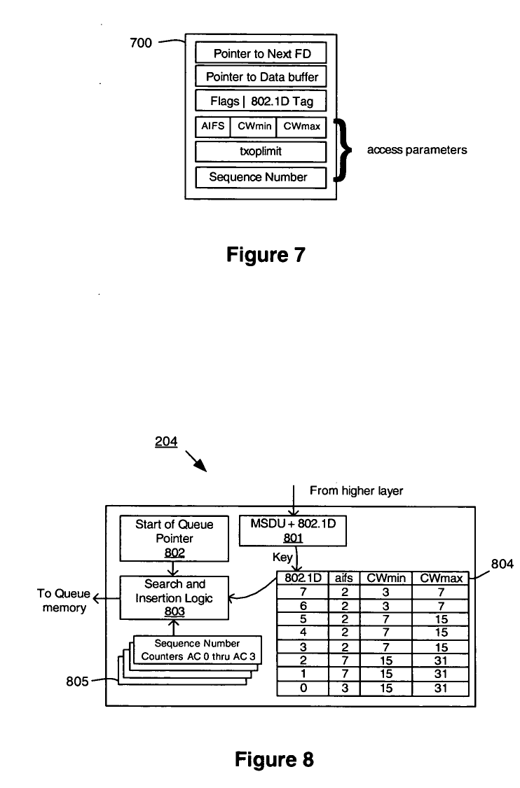

FIG. 7 shows an illustrative arrangement of a modified frame descriptor 700. The frame descriptor 700 may be stored in memory or another computer-readable medium. The frame descriptor 700 may include a pointer to the next frame descriptor, a pointer to an associated one of the data buffers (e.g., data buffer 304, 305, or 306), one or more flags, an IEEE 802.1D user priority tag, one or more access parameters, and/or a sequence number. As previously discussed, the access parameters may include an AIFS interval and/or a CW interval defmed by CWmin and CWmax.

FIG. 8 shows an illustrative functional block diagram of the priority resolver 204. The priority resolver 204 as shown includes an 802.1D tag extraction portion 801 that determined the 802.1D tag associated with an MSDU. The 802.1D tag is used in a lookup table 804 that determines the access parameters associated with the particular 802.1D tag. The lookup table 804 may contain some or all of the information shown in Table 1. For example, if an MSDU has an 802.1D tag of 3, then the associated access parameters may be aifs=2, CWmin=7, and CWmax=15. These determined access parameters are then added to the frame descriptor associated with the MSDU. Because the transmit queue 307 may be implemented as a linked list, the priority resolver 204 may have a start-of-queue pointer 802 that points to the frame descriptor associated with the packet at the start of the transmit queue 307. The priority resolver 204 may further have search and insertion logic 803 that determines where to insert the packet into the transmit queue 307 in accordance with the packet's priority. The priority resolver 204 may further have one or more counters 805 that provide CSMA/CA sequence numbers for each of the access categories.

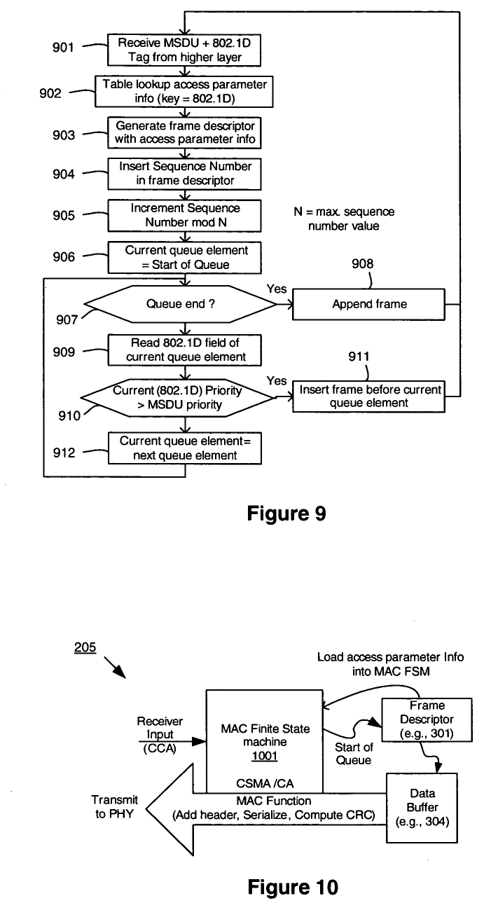

The operation of the priority resolver 204 is discussed with reference to FIG. 9. In step 901, the priority resolver 204 receives an MSDU, including associated priority information such as the 802.1D tag, from the upper layer 203. This MSDU will be referred to as the insertion packet. In step 902, the priority resolver 204 determines the access parameters that are associated with the 802.1D tag of the insertion packet. In step 903, the priority resolver 204 generates a frame descriptor for the insertion packet that includes the determined access parameters. In step 904, the priority resolver 204 inserts an appropriate sequence number for the insertion packet based on the access category associated with the 802.1D tag. In step 905, the sequence number is then incremented modulo N, where N is the maximum sequence number as defined by the IEEE 802.11 standard.

Steps 906-912 determine where the insertion packet should be inserted in the transmit queue 307. In step 906, a pointer is established that points to a particular position within the transmit queue 307. That position will be referred to as the current queue position. The pointer is initialized to point to the start of the transmit queue 307. In step 907, the priority resolver 204 determines whether the current queue position is at the end of the transmit queue 307. As previously mentioned, the current queue position at this point in the process is the start of the transmit queue 307, not the end. Thus, at step 909, the priority resolver 204 reads the 802.1D field associated with whichever packet is at the current queue position in the transmit queue 307. In step 910, if the 802.1D priority of the insertion packet is greater than the priority of the packet in the current queue position, then in step 911 the insertion packet is inserted into the transmit queue 307 one position ahead of the current queue position. However, if the priority of the insertion packet is not greater than the priority of the packet in the current queue position, then in step 912 the pointer is incremented such that the current queue position moves backward in the queue by one position. Steps 906-912 are repeated as needed until the insertion packet is inserted into the transmit queue 307. If the current queue position has been incremented to the end of the transmit queue 307, then in step 908 the insertion packet is inserted at the end of the transmit queue 307.

A packet may be inserted in the transmit queue 307 in any of a number of ways depending upon how the transmit queue 307 is implemented. For example, where the transmit queue 307 literally contains the substances of the packets, then the insertion packet is inserted by physically copying the insertion packet into a memory location of the queue. More likely, however, the transmit queue 307 is actually a linked list that links to the frame descriptors of the packets “contained” in the transmit queue 307. Each frame descriptor contains a reference to the next frame descriptor in the transmit queue 307. In this case, the insertion packet may be inserted simply by adding a reference to the insertion packet into a memory location of the transmit queue 307.

While the priority resolver 204 maintains the transmit queue 307, the transmit engine 205 transmits the packets in the transmit queue 307 in accordance with the access parameters associated with the packets. Thus, the transmit engine 205 may be dynamically programmable in accordance with the access parameters of the packets that are to be transmitted. The transmit engine 205 may operate as shown, for example, in FIG. 10. The transmit engine 205 receives the frame descriptor of the next packet to be transmitted (e.g., frame descriptor 301, 302, or 303), which will be the frame descriptor at the start of the transmit queue 307. The frame descriptor may contain a reference to its associated packet, wherein the packet may be stored in one of the data buffers 304, 305, or 306 of the transmit queue 307. The transmit engine 205 may use a MAC finite state machine 1001 that performs several pre-transmission services. The MAC finite state machine 1001 generates a cyclic redundancy check (CRC) value to allow the integrity of the packet to be verified upon receipt of the transmission, and adds a header to the packet. Finally, the MAC finite state machine 1001 serializes the packet into a serial stream of bits for transmission as a frame. The frame may one or more packets in series.

Following an initial access grant, the transmit engine 205 loads the txoplimit of the frame to be transmitted that is carried in the frame descriptor into a txop duration timer (part of the MAC finite state machine 1001). The actual transmit time plus the time for acknowledgement and overhead is deducted from the txop duration timer according to the rules defined in 802.11e/WME. The transmit engine 205 maintains ownership of the shared wireless medium until either the txop limit duration counter reaches zero or no packet is to be transmitted with same 802.1D tag or access category, respectively. The txop duration timer may be set only once after obtaining the initial transmit opportunity following the medium access arbitration process. Subsequent transmission with the same transmit opportunity preferably would not cause the txop duration timer to be reset.

In alternative embodiments used for existing hardware solutions and application specific devices that generate one type of data with a fixed priority, access parameters may be adjusted on a per-packet basis via explicit configuration of the hardware using configuration registers. For this purpose, the access parameters may be programmed into the hardware prior to the transfer of the MPDU into the transmission engine 205. As a result the host may invoke multiple operations for configuring the hardware prior to transmission. Depending on the hardware interface, the packet may be written to the hardware via input/output commands, or an isolated short buffer (e.g., a transfer buffer) may be created from which the transmission engine 205 fetches the data using, e.g., direct memory access (DMA). Where such input/output commands are used, the hardware may be configured with the appropriate access parameter values before a packet is written into the input/output registers of the transmission engine 205. In the case of DMA, the hardware may be configured prior to copying the MPDU into the transmit buffer.

While illustrative systems and methods as described herein embodying various aspects of the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments. Also, the invention has been defined using the appended claims, however these claims are exemplary in that the invention is intended to include the elements and steps described herein in any combination or sub-combination. It will also be appreciated and understood that modifications may be made without departing from the true spirit and scope of the invention.

1. A method for handling a plurality of packets for transmission into a shared medium, the packets having a plurality of different priorities, the method comprising steps of:
generating a frame descriptor for each of the packets, each frame descriptor including at least one access parameter associated with the priority of the respective packet; and
ordering the packets in accordance with the priorities of the packets.

2. The method of claim 1, wherein the step of ordering the packets includes ordering the packets in a single transmit queue.

3. The method of claim 2, further including a step of transmitting data in the packets in accordance with the at least one access parameter associated with each respective packet.

4. The method of claim 1, wherein the step of ordering the packets includes adding to at least some of the frame descriptors a reference to another one of the frame descriptors.

5. The method of claim 1, wherein the priorities are IEEE 802.11/WME access categories.

6. The method of claim 1, wherein the priorities are IEEE 802.1D tags.

7. The method of claim 1, wherein the at least one access parameter includes an arbitration interfrae spacing value, a contention window minimum value, a contention window maximum value, and a transmit opportunity limit duration.

8. A computer-readable medium storing computer-executable instructions for performing the method of claim 1.

9. A method, comprising generating a plurality of IEEE 802.11 frame descriptors each including at least one access parameter associated with a different respective packet.

10. The method of claim 9, wherein the at least one access parameter includes an arbitration interframe spacing value, a contention window minimum value, a contention window maximum value, and a transmit opportunity limit duration.

11. A computer-readable medium storing computer-executable instructions for performing the method of claim 9.

12. A method for handling packets in an IEEE 802.11 WME apparatus, the method comprising steps of: receiving a plurality of packets, the packets being associated with a plurality of different WME access categories;
ordering the packets in a same single transmit queue in accordance with the access categories associated with the packets; and
transmitting data in the packets over a shared wireless medium.

13. The method of claim 12, further including a step of determining at least one access parameter for each packet depending upon the access category of the packet.

14. The method of claim 13, wherein the step of transmitting the data includes transmitting the data in accordance with the at least one access parameter associated with each respective packet.

15. The method of claim 13, further including a step of storing each of the at least one access parameters in a different frame descriptor associated with each respective packet.

16. The method of claim 13, wherein the at least one access parameter includes an arbitration interframe spacing value, a contention window minimum value, a contention window maximum value, and a transmit opportunity limit duration.

17. The method of claim 12, further including a step of transmitting a sequence number for each packet, the sequence numbers being a function of the access categories of the packet.

18. The method of claim 12, further including a step of receiving an IEEE 802.1D tag for each of the packets and determining the access categories for the packets based on the IEEE 802.1D tags.
